(19) United States
(12) Patent Application Publication
(10) Pub. No.: US 2026/0252464 A1
(43) Pub. Date: Aug. 27, 2026

(54) ARTIFICIAL INTELLIGENCE SUPPORTED APPLICATION TESTING AUTOMATION FRAMEWORK FOR DISCOVERY AND ERROR CORRECTION

(71) Applicant: Palo Alto Networks, Inc., Santa Clara, CA (US)

(72) Inventors: Yu Fu, Sunnyvale, CA (US); Lin Li, Sunnyvale, CA (US); Wenjun Hu, Santa Clara, CA (US); Mei Wang, Saratoga, CA (US)

(21) Appl. No.: 19/059,960

(22) Filed: Feb. 21, 2025

(51) Int. Cl. G06F 11/34; G06F 11/07; G06F 11/3698

(52) U.S. Cl. CPC G06F 11/3457; G06F 11/0766; G06F 11/3698

(57) ABSTRACT

A testing framework conducts a dialogue with a multi-modal foundation model to determine how to interact with an application via a user interaction emulator tool based on images captured from the UI of the application. Initially, the testing framework will capture an image of the application UI. The testing framework then prompts the foundation model to explain how to interact with the application to achieve a function of the application given the captured image. The testing framework derives commands from the model response for running the user interaction emulator tool and captures an image of the application UI after the interaction and again prompts the foundation model to determine whether the function was successfully performed or to explain a failure. The testing framework continues the dialogue with successive prompts for interaction with the application informed by the explanation of preceding failure.

### BACKGROUND

The disclosure generally relates to data processing (e.g., CPC subclass G06F) and to computing arrangements based on specific computational models (e.g., CPC subclass G06N).

Rapid developments in artificial intelligence (Al) technologies have spawned numerous terms with fluid meanings. Recently, Al technologies are frequently referred to with the terms large language model (LLM), generative Al, and foundation model. Many of these technologies are based on or relate to the "Transformer" architecture. A "Transformer" was introduced in VASWANI, et al. "Attention is all you need" presented in Proceedings of the 31st International Conference on Neural Information Processing Systems on Dec. 2017, pages 6000-6010. The Transformer is a first sequence transduction model that relies on attention and eschews recurrent and convolutional layers. The Transformer architecture has been referred to as a "foundational model." The Center for Research on Foundation Models at the Stanford Institute for Human-Centered Artificial Intelligence used this term in an article "On the Opportunities and Risks of Foundation Models" to describe a model trained on broad data at scale that is adaptable to a wide range of downstream tasks. There has been subsequent research in similar Transformer-based sequence modeling. The architecture of a Transformer model typically is a neural network with transformer blocks/layers, which include self-attention layers, feed-forward layers, and normalization layers. The Transformer model learns context and meaning by tracking relationships in sequential data.

Some LLMs are based on the Transformer architecture. An LLM is "large" because the training parameters are typically in the billions and have been approaching a trillion parameters. Al technologies are not limited to LLMs and research and utilization of "lightweight" language models (i.e., fewer parameters than large) has grown. Language models can be pre-trained to perform general-purpose tasks or tailored to perform specific tasks. Tailoring of language models can be achieved through various techniques, such as prompt engineering and fine-tuning.

### BRIEF DESCRIPTION OF THE DRAWINGS

Embodiments of the disclosure may be better understood by referencing the accompanying drawings.

FIG. 1 is a diagram of an AI supported testing framework that automatically tests an application to discover changes and detect errors.

FIG. 2 is a flowchart of example operations for an automated application test supported with AI.

FIG. 3 depicts an example computer system with an AI supported application testing automation framework.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

A "prompt" refers to input to a foundation model, and "prompting" refers to the act of submitting a prompt to a model to perform inference based on the submitted prompt. A prompt at least includes a natural language task instruction to the model. A prompt can also include other prompt components. Examples of other prompt components include role, context, constraints, and examples. In other words, a prompt is a natural language task instruction and other information that can assist the model in performing the task successfully. A prompt can have more than one task instruction, and prompts can be chained to incorporate responses from the model into a subsequent prompt. A prompt can be entered by a user and/or constructed from a prompt template.

Use of the phrase "at least one of' preceding a list with the conjunction "and" should not be treated as an exclusive list and should not be construed as a list of categories with one item from each category, unless specifically stated otherwise. A clause that recites "at least one of A, B, and C" can be infringed with only one of the listed items, multiple of the listed items, and one or more of the items in the list and another item not listed.

### Introduction

In the contemporary software landscape, the proliferation of applications across diverse platforms, such as web-based, desktop, and mobile platforms, demands robust application automation solutions that can accurately and efficiently identify and interact with application functionalities. Traditional application automation techniques rely primarily on hard-coded button clicks and predefined workflows. These traditional techniques struggle to adapt to the dynamic nature of continuous development (also referred to as continuous integration and continuous deployment (CI/CD)). As applications undergo updates, including function deprecations or user interface (UI) modifications, these rigid traditional techniques do not address the challenges of continuous development practice and lead to increased maintenance overhead and decreased reliability in automated processes.

### Overview

A testing framework has been developed that leverages artificial intelligence (AI) (i.e., generative AI or a foundation model), to adapt automated testing to the challenges of continuous development. This "AI supported testing framework" interacts or conducts a dialogue with a multi-modal foundation model to determine how to interact with an application via a user interaction emulator tool based on images captured from the UI of the application. Initially, the AI supported testing framework will capture an image of the application UI. The AI supported testing framework then prompts the foundation model to explain how to interact with the application to achieve a function of the application given the captured image. The AI supported testing framework derives commands from the model response for running the user interaction emulator tool. The AI supported testing framework captures an image of the application UI after the interaction and again prompts the foundation model to determine whether the function was successfully performed or to explain a failure. The AI supported testing framework continues the dialogue with successive prompts for interaction with the application informed by the explanation of preceding failure until the function is successfully performed or a dialogue limit is reached. For each run of the application, the AI supported testing framework collects traffic generated from the application. The AI supported testing framework facilitates efficient discovery of application deployments and adaptations to changes that arise from continuous development. In addition, the AI supported testing framework collects information about errors from the interactions, including the application traffic, and allows for efficient error detection and correction.

### Example Illustrations

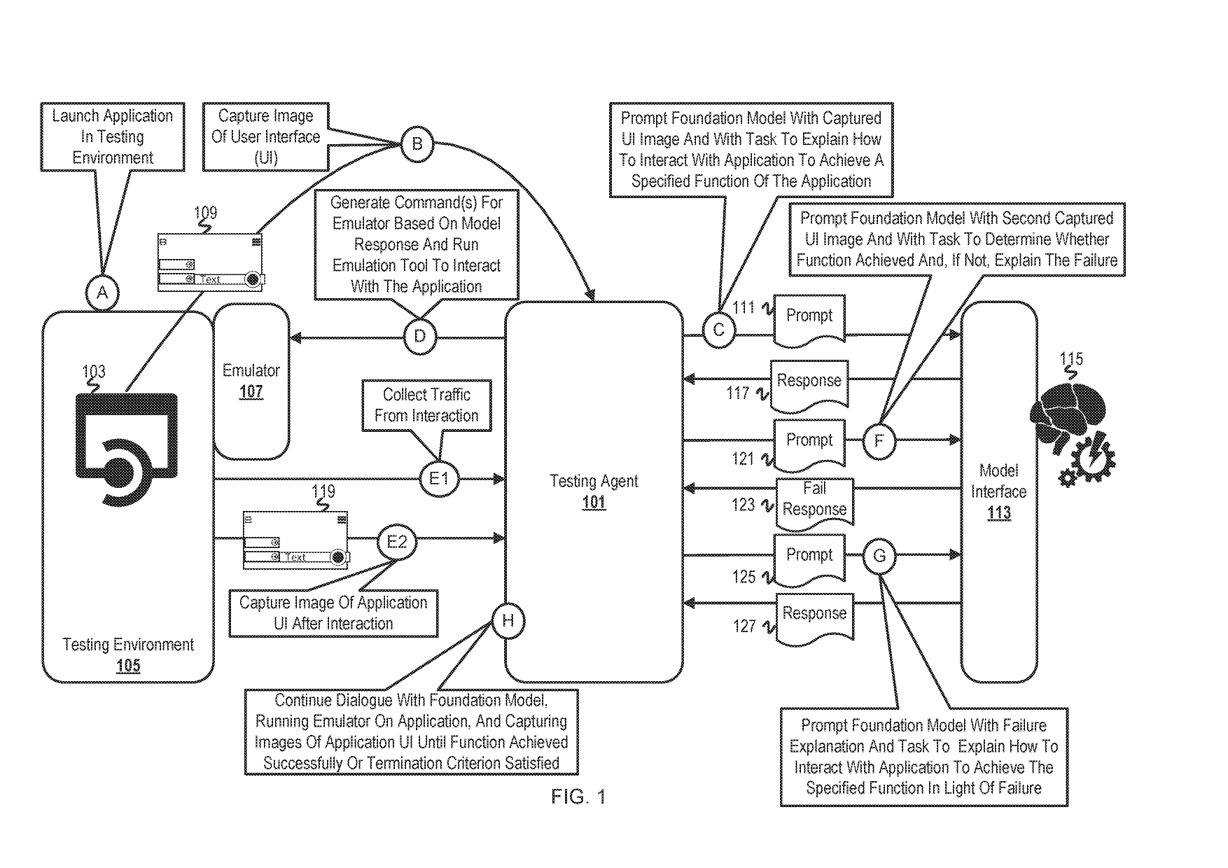

FIG. 1 is a diagram of an AI supported testing framework that automatically tests an application to discover changes and detect errors. The AI supported testing framework includes a testing agent 101, a testing environment 105, an emulator 107, and a foundation model 115 (e.g., LLM). Interactions with the foundation model 115 are via a model interface 113, such as an application programming interface (API). The foundation model 115 is described as part of the AI supported testing framework, but may be a remotely hosted LLM. In FIG. 1, an application 103 is being tested.

FIG. 1 is annotated with a series of letters A - D, El, E2, and F - H representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the AI supported testing framework launches the application 103 in the testing environment 105. The testing environment 105 (e.g., an isolated virtual machine or container) is configured according to testing parameters. For instance, the testing environment 105 is configured for a platform or operating system to which the application 103 is deployed.

At stage B, the testing agent 101 captures an image 109 of the UI of the application 103. The testing agent 101 captures a full screenshot of the application 103 to allow for determination of coordinates of interactive elements of the UI.

At stage C, the testing agent 101 prompts the foundation model 115 with the captured UI image 109 and with a task to explain how to interact with the application 103 to achieve a specified function of the application. For example, the testing agent 101 can construct a prompt 111 with a task for the foundation model 115 to explain how to interact with the application based on the captured image 109 to start or schedule an online meeting, assuming the application 103 is a meeting application. The task instructions can specify that the foundation model 115 identifies coordinates of the interactive elements detected in the image 109 and that the explanation for how to interact with the application 103 refers to the coordinates to allow generation of commands for an emulator. The task instructions in the prompt 111 can identify the emulator 107 (e.g., identify the emulator 107 as a Selenium tester or PyAutoGUI automation module) and instruct the foundation model 115 to explain the interaction to guide the emulator 107. The foundation model 115 responds to the prompt 111 with a response 117.

At stage D, the testing agent 101 generates a command(s) for the emulator 107 based on the model response 117. If the model response 117 included commands for the emulator 107, then the testing agent 101 can extract the commands and run the emulator 107 to interact with the application 103 within the testing environment 105 according to the commands. Alternatively, the testing agent 101 can parse the response 117 and map keywords in the response 117 to commands of the emulator 107.

At stages El and E2, the testing agent 101 collects information from running the application 103. At stage El, the testing agent 101 collects traffic from the interaction with the application 103 by the emulator 107. The testing environment 105 can be configured to capture and respond to traffic from the application 103, such as API requests. At stage E2, the testing agent 101 captures a second image 119 or screenshot of the application 103 resulting from the interactions by the emulator 107.

At stage F, the testing agent 101 prompts the foundation model 115 with the second captured image 119 and with a task to determine whether the function specified in the prompt 111 was achieved. The testing agent 101 constructs a prompt 121 with task instructions to determine whether the function was successfully performed and to explain why the function was not successfully performed if that is the case. The foundation model 115 responds to the prompt 121 with a fail response 123 in this illustration. In some cases, the dialogue is a single turn. If a failure is detected, then the dialogue will be multi-turn.

At stage G, the testing agent 101 prompts the foundation model 115 with the previously provided explanation for the failure to perform the function successfully and against tasks the foundation model 115 with explaining how to interact with the application 103 to successfully perform the specified function. The testing agent 101 constructs a prompt 125 that includes the image 119, the failure explanation, and task instructions to explain how to interact with the application to successfully perform the function but differently than the previous explanation.

Stage H is not a single stage of operations but represents a continuation of the dialogue. At stage H, the testing agent 101 continues the dialogue with the foundation model based on successively generating commands for the emulator based on responses from the foundation model, running the emulator 107 on the application 103, and capturing resulting images of the application 103. After each interaction and with each captured image, the testing agent 101 again prompts the foundation model 115 to determine whether the interaction was successful or a failure and to explain any failure. This continues until either the function is successfully performed or a termination criterion is satisfied. For example, 10 turns or 10 runs can be defined as a termination criterion for the automated testing.

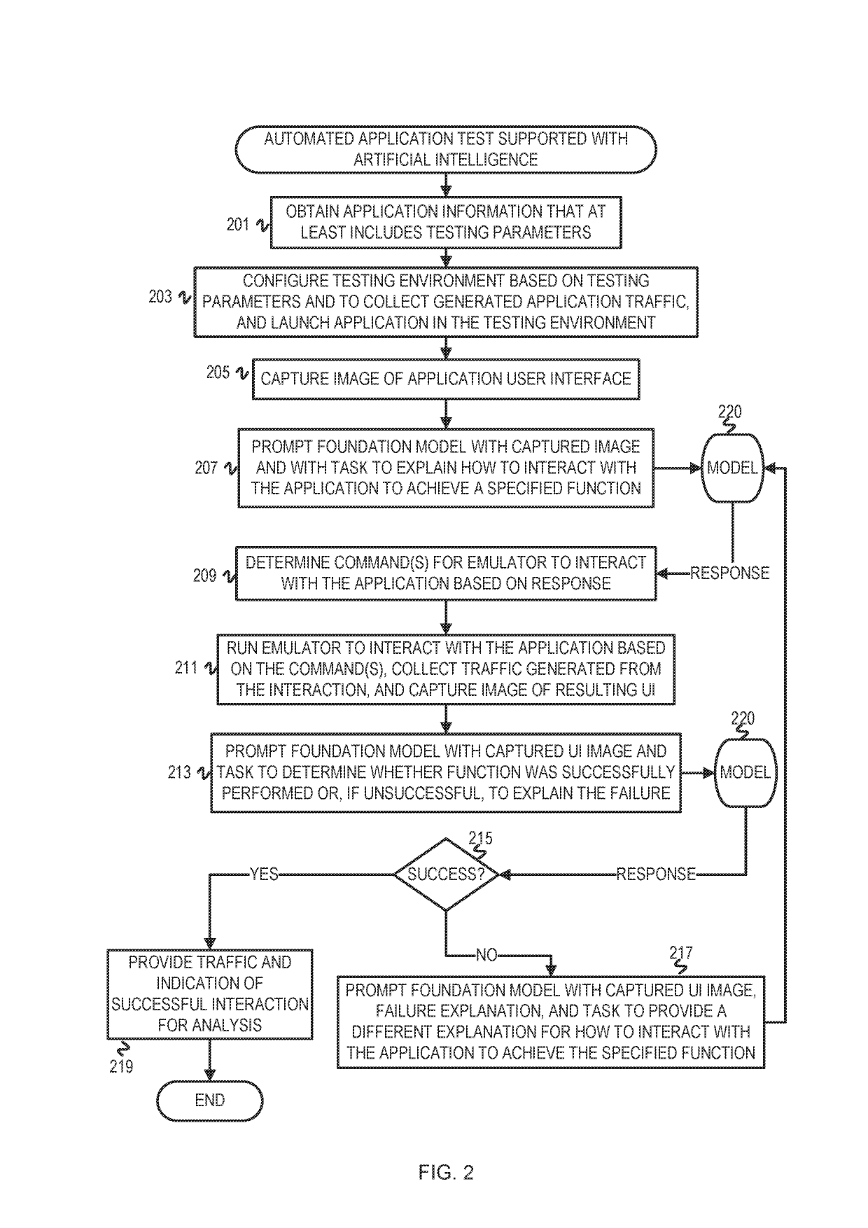

FIG. 2 is a flowchart of example operations for an automated application test supported with AI. The example operations are described with reference to the AI supported testing framework for consistency with FIG. 1 and ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. FIG. 2 depicts a foundation model 220 with which the AI supported testing framework interacts. It is depicted twice due to the drawings space constraints.

At block 201, the AI supported testing framework obtains application information that at least includes testing parameters. The testing parameters include platforms or an operating system(s) on which the application is deployed or to be deployed. The testing parameters also include one or more functions of the application to be tested. The AI supported testing framework can obtain the information by prompting a foundation model and/or scraping a website of the application. For instance, the AI supported testing framework can prompt a model to identify the platforms on which an application is available and extract from a manual or brochure for the application the functions that can be performed. The testing parameters can specify one of the functions to test or multiple of the functions.

At block 203, the AI supported testing framework configures a testing environment based on the testing parameters. The AI supported testing framework can instantiate a testing environment for each platform or configure the testing environment to repeat interactions for each platform. In addition, the AI supported testing framework configures the testing environment to collect application traffic generated from running the application. After configuration, the AI supported testing framework launches the application in the configured testing environment.

At block 205, the AI supported testing framework captures an image of the application user interface. The AI supported testing framework takes a screenshot of the application user interface.

At block 207, the AI supported testing framework prompts the foundation model 220 with the captured image and with a task to explain how to interact with the application to achieve the specified function. The AI supported testing framework can construct a prompt based on a prompt template that includes task instructions directing the foundation model 220 to identify coordinates of interactive elements depicted in the captured image and to explain how to interact with the application with respect to the interactive elements based on the description of the application to achieve the function. The task instructions can also specify each step and explain order of the steps to achieve the function.

At block 209, the AI supported testing framework determines a command(s) for a user interaction emulator to interact with the application based on a response from the foundation model 220. The AI supported testing framework examines the response from the foundation model 220 and extracts the coordinates and interactions specified by the response and any ordering specified by the response.

At block 211, the AI supported testing framework runs the emulator to interact with the application based on the command(s) extracted from the response. The AI supported testing framework collects application traffic generated from the interaction. The AI supported testing framework captures an image of the UI rendered as a result of the interaction.

At block 213, the AI supported testing framework prompts the foundation model 220 with the captured UI image and with a task to determine whether the specified function was successfully performed or, if unsuccessful, to explain the failure. The AI supported testing framework can construct the prompt using a prompt template that includes task instructions directing the foundation model 220 to determine whether the function was achieved and if not to explain in detail how failure is represented in the captured image.

At block 215, the AI supported testing framework determines whether the function was successfully performed based on a response from the foundation model 220. If performing the specified function was not achieved, then operational flow proceeds to block 217. If the function was successfully performed, then operational flow proceeds to block 219.

At block 217, the AI supported testing framework prompts the foundation model 220 with the captured image of the UI resulting from the interaction, the explanation of the failure, and a task to provide a different explanation for how to interact with the application to achieve the specified function. When constructing the prompt, the AI supported testing framework indicates that the conversation history is to be included as context to inform the explanation. After prompting the model 220, operational flow returns to block 209 to determine a command(s) for the emulator based on an additional response provided by the model 220.

At block 219, the AI supported testing framework provides the collected traffic and indication of successful interaction for analysis. With the collected traffic, the interactions can be analyzed to detect the errors that may have been created from an update to the application. Even if the function was successfully performed, the collected traffic can be analyzed to determine usage patterns resulting from updates.

Implementations can also limit the dialogue to a threshold number of retries or a threshold number of times to run the application. For instance, the framework can determine whether the limit has been reached after block 215.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a "circuit," "module" or "system." The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine- readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

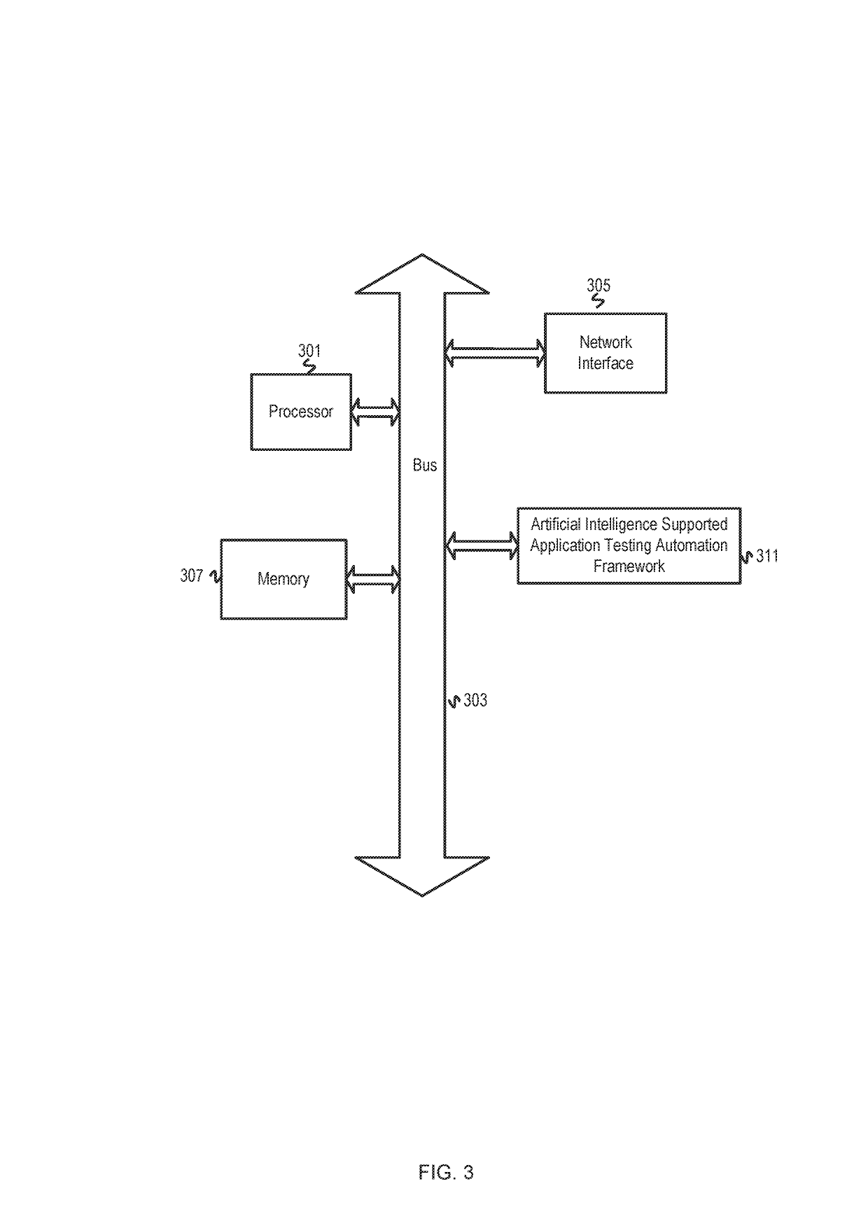

FIG. 3 depicts an example computer system with an AI supported application testing automation framework. The computer system includes a processor 301 (possibly including multiple processors, multiple cores, multiple nodes, and/or implementing multi-threading, etc.). The computer system includes memory 307. The memory 307 may be system memory or any one or more of the above already described possible realizations of machine-readable media. The computer system also includes a bus 303 and a network interface 305. The system also includes AI supported an application testing automation framework 311 that conducts a dialogue with a multi- modal foundation model to determine how to interact with an application to test the application based on screen captures of the application. The AI supported application testing automation framework 311 has access to a prompt template to task a foundation model with explaining how to interact with an application to successfully perform one or more specified functions and a prompt template to task the foundation model with determining whether a function was performed and, if not, explain the reason for the failure. The prompt template for the initial analysis includes a placeholder for a screenshot of the application UI. The prompt template for subsequent interactions can include a placeholder for the resulting UI or for the initial and the resulting UI. Any one of the previously described functionalities may be partially (or entirely) implemented in hardware and/or on the processor 301. For example, the functionality may be implemented with an application specific integrated circuit, in logic implemented in the processor 301, in a co-processor on a peripheral device or card, etc. Further, realizations may include fewer or additional components not illustrated in FIG. 3 (e.g., video cards, audio cards, additional network interfaces, peripheral devices, etc.). The processor 301 and the network interface 305 are coupled to the bus 303. Although illustrated as being coupled to the bus 303, the memory 307 may be coupled to the processor 301.

1. A method comprising:capturing a first image of a user interface of an application;
interacting with a large language model (LLM) to guide a user interaction emulation tool to achieve a first function of the application, wherein the interacting comprises,
prompting the LLM to explain how to interact with the application to achieve the first function, wherein the prompting comprises submitting to the LLM the first image and a task instruction to explain how to interact with the application to achieve the first function;
running a user interaction emulation tool on the application in a testing environment based on an explanation for interacting in a response from the LLM;
capturing a second image of the application after running the user interaction emulation tool;
prompting the LLM to determine whether the first function was successfully performed and explain a reason for failure if the first function was not successfully performed, wherein prompting comprises submitting to the LLM the second image and task instructions to determine whether the first function was successfully performed and explain a reason for failure if the first function was not successfully performed; and
collecting traffic generated from the application running in the testing environment.

2. The method of claim 1 further comprising, based on a response from the LLM indicating failure to achieve the first function based on the second image:
prompting the LLM to provide a different explanation of how to interact with the application to achieve the first function, wherein the prompting comprises submitting to the LLM the second image and the reason for the failure as context.

3. The method of claim 1 further comprising prompting the LLM or another LLM to obtain the description of the application.

4. The method of claim 1, wherein the task instruction to explain how to interact with the application comprises an instruction to the LLM to identify a coordinate of a graphical element to select or click, to identify coordinates of graphical elements to select or click and a sequence for selecting or clicking, or an instruction to identify a command to submit to the application and how to submit the command.

5. The method of claim 1 further comprising repeatedly interacting with the LLM until either reaching a retry limit or successfully performing the first function.

6. The method of claim 1 further comprising:
obtaining a description of the application and steps to perform to achieve a testing goal for the application, wherein the first function corresponds to a first of the steps and prompting the LLM to explain how to interact with the application based on the first image further comprises submitting the description of steps as context and wherein the description of the application comprises at least testing parameters of the application; and
configuring a testing environment based, at least in part, on the description of the application.

7. The method of claim 6 further comprising successively interacting with the LLM to achieve a function corresponding to each successive step subsequent to the first step, wherein the successively interacting is depending upon successfully performing a function.

8. The method of claim 1, wherein the testing parameters comprise one or more of platforms, devices, and interfaces.

9. A non-transitory, machine-readable medium having stored thereon program code comprising instructions to:
capture a first image of a user interface of an application;
interact with a large language model (LLM) to guide a user interaction emulation tool to achieve a first function of the application, wherein the instructions to interact comprise instructions to,
prompt the LLM to explain how to interact with the application to achieve the first function, wherein the instructions to prompt comprise instructions to submit to the LLM the first image and a task instruction to explain how to interact with the application to achieve the first function;
run a user interaction emulation tool on the application in a testing environment based on a response from the LLM;
capture a second image of the application after running the user interaction emulation tool;
prompt the LLM to determine whether the first function was successfully performed and explain a reason for failure if the first function was not successfully performed, wherein the instructions to prompt comprise instructions to submit to the LLM the second image and task instructions to determine whether the first function was successfully performed and explain a reason for failure if the first function was not successfully performed; and
collect traffic generated from the application running in the testing environment.

10. The non-transitory, machine-readable medium of claim 9, wherein the program code further comprises instructions to:
prompt the LLM or another LLM to obtain a description of the application, wherein the description comprises at least testing parameters of the application; and
configure the testing environment based, at least in part, on the description of the application.

11. The non-transitory, machine-readable medium of claim 9, wherein the program code further comprises instructions to, based on a response from the LLM indicating failure to achieve the first function based on the second image, prompt the LLM to provide a different explanation of how to interact with the application to achieve the first function, wherein the instructions to prompt comprises instructions to submit to the LLM the second image and the reason for the failure as context.

12. The non-transitory, machine-readable medium of claim 9, wherein the task instruction to explain how to interact with the application comprises an instruction to the LLM to identify a coordinate of a graphical element to select or click, to identify coordinates of graphical elements to select or click and a sequence for selecting or clicking, or an instruction to identify a command to submit to the application and how to submit the command.

13. The non-transitory, machine-readable medium of claim 9, wherein the program code further comprises instructions to repeatedly interact with the LLM until either reaching a retry limit or successfully performing the first function.

14. The non-transitory, machine-readable medium of claim 9, wherein the program code further comprises instructions to obtain a description of steps to perform to achieve a testing goal for the application, wherein the first function corresponds to a first of the steps and wherein the instructions to prompt the LLM to explain how to interact with the application based on the first image further comprise instructions to submit the description of steps as context.

15. The non-transitory, machine-readable medium of claim 14, wherein the program code further comprises instructions to successively interact with the LLM to achieve a function corresponding to each successive step subsequent to the first step, wherein the instructions to successively interact execute dependent upon successfully performing a function.

16. An apparatus comprising:
a processor; and
a machine-readable medium having stored therein instructions executable by the processor to cause the apparatus to,
capture a first image of a user interface of an application;
interact with a large language model (LLM) to guide a user interaction emulation tool to achieve a first function of the application, wherein the instructions to interact comprise instructions to,
prompt the LLM to explain how to interact with the application to achieve the first function, wherein the instructions to prompt comprise instructions to submit to the LLM the first image and a task instruction to explain how to interact with the application to achieve the first function;
run a user interaction emulation tool on the application in a testing environment based on a response from the LLM;
capture a second image of the application after running the user interaction emulation tool;
prompt the LLM to determine whether the first function was successfully performed and explain a reason for failure if the first function was not successfully performed, wherein the instructions to prompt comprise instructions to submit to the LLM the second image and task instructions to determine whether the first function was successfully performed and explain a reason for failure if the first function was not successfully performed; andcollect traffic generated from the application running in the testing environment.

17. The apparatus of claim 16, wherein the machine-readable medium further has stored thereon instructions executable by the processor to cause the apparatus to:
prompt the LLM or another LLM to obtain a description of the application, wherein the description comprises at least testing parameters of the application; and
configure the testing environment based, at least in part, on the description of the application.

18. The apparatus of claim 16, wherein the machine-readable medium further has stored thereon instructions executable by the processor to cause the apparatus to, based on a response from the LLM indicating failure to achieve the first function based on the second image, prompt the LLM to provide a different explanation of how to interact with the application to achieve the first function, wherein the instructions to prompt comprise instructions to submit to the LLM the second image and the reason for the failure as context.

19. The apparatus of claim 16, wherein the task instruction to explain how to interact with the application comprises an instruction to the LLM to identify a coordinate of a graphical element to select or click, to identify coordinates of graphical elements to select or click and a sequence for selecting or clicking, or an instruction to identify a command to submit to the application and how to submit the command.

20. The apparatus of claim 16, wherein the machine-readable medium further has stored thereon instructions executable by the processor to cause the apparatus to repeatedly interact with the LLM until either reaching a retry limit or successfully performing the first function.

21. The apparatus of claim 16, wherein the machine-readable medium further has stored thereon instructions executable by the processor to cause the apparatus to obtain a description of steps to perform to achieve a testing goal for the application, wherein the first function corresponds to a first of the steps and wherein the instructions to prompt the LLM to explain how to interact with the application based on the first image further comprise instructions to submit the description of steps as context.
